(19) United States
(12) Patent Application Publication
(10) Pub. No.: US 2018/0266177 A1
(43) Pub. Date: Sep. 20, 2018

(54) HIGH SPEED ROLL UP DOOR

(71) Applicant: Bekir Tolga SIVRITEPE, Izmir (TR)

(72) Inventor: Bekir Tolga SIVRITEPE, Izmir (TR)

(21) Appl. No.: 15/542,307

(22) PCT Filed: Dec. 21, 2015
(86) PCT No.: PCT/TR2015/050258

§ 371 Date: Jul. 7, 2017

(30) Foreign Application Priority Data
Oct. 21, 2015 (TR) 2015/13095

(51) Int. Cl. E06B 9/58; E06B 9/06; E06B 9/13; E06B 9/17

(52) U.S. Cl. CPC E06B 9/582; E06B 9/0692; F24F 2009/005; E06B 9/17046; E06B 2009/17069; E06B 9/13

(57) ABSTRACT

An improvement in the insulation of the rapid rolling type doors has an insulation piece positioned longitudinally on the stems to enable the door to operate well by providing the removal of accumulated air in the curtain system from the stems during up and down movement of the door and thereby preventing icing in the stems. Ventilation holes provide the discharge of the compressed air. A hole shutter curtain is provided wherein one side is fixed on the curtain and the other side is free and which overlies the ventilation holes by acting as a skirt when downward movement of the door is completed and prevents heat transfer.

### TECHNICAL FIELD

This invention will be used in Rapid Rolling type doors that are made up of two drums and are generally used for insulation purposes. In general, this invention relates to an insulation door, insulation of which is increased and on which innovations are made.

### BACKGROUND OF THE INVENTION

In such type of doors, which are generally used for separation of places in which temperature of one side is below 0 degree and the temperature of other side is above 0 degree, the existing air in the environment streams into the stems while the door is operating and open. One of the drawbacks of the available application is that the stems of the doors are not insulated. The existing air is exactly 0 degrees such that the water vapor in the air condenses to ice when the door closes and icing occurs inside the stems. This negatively affects the operation of the door. In the available applications, base profile is also not sufficiently insulated. This also leads to ice formation in the base profile, as does in the columns. While the door is operating, the two available insulation curtains in the door operate independently from the two outer independent canvas curtains and the distance between them changes when the door is open and closed depending on the height of the door. This change may reach up to 20 to 40 cm. In the available system, the position of the inner curtains should generally fits exactly one-to-one to the base profile when the door is closed such that the insulation could be provided. In practice, this does not occur and the curtain remains a few cm above such that this leads to insulation problem and icing therein. Or, it presses more on the base profile which in turn leads the pressing portion to form a bending to the outer canvas, causes skewing of the base profile, and leads to a distorted sense in the customer's eyes. Moreover, it leads to problems with the customer by ruining the image of the product. Due to the acceleration that occurs during rapid opening of the door, the independent inner insulation materials occasionally can rise up more, be compressed, roll over, and cause major malfunctions, as they are not connected to the base profile.

In the available similar systems, in the stems, sufficient insulation could not be provided due to the presence of air circulation into the carrier system and warm and cold air meet therein and then turn into ice, which in turn leads to conditions preventing the door from operating. Since this condition was closed according to the subject of the invention, icing in the stems was prevented and thereby the problem in the up and down movement of the door was overcome. Due to this system being such insulated, the trapped air between the curtains when the door is opened leads to pressure effect. The removal of the air pressure is provided by the new curtain system by opening ventilation holes on the curtain system. Meanwhile, insulation loss due to ventilation holes is prevented by means of a hole shutter curtain.

### OBJECT OF THE INVENTION

This invention is made up of a specially designed polyester base profile and has no heating bridge. Icing problem will be much less in the base. It may cover the manufacturing errors up to 140-mm portion in length in the curtain such that it enables the trouble-free operation of the door. The holes providing the removal of air pressure that is rapidly formed upwards during door opening will enable healthy operation of the device. Moreover, internally operating insulation curtains being connected to the base profile with bunge cables, a less stretchable rope derivative, prevents the curtain from bouncing and enables it to come down in the correct position.

The primary objective of the invention is to prevent icing inside the stems by insulating the stems that guide the up and down movement of the door, accordingly enabling more convenient operation of the door.

Another objective of the invention is to provide discharge of the trapped air by means of the formed ventilation holes. In the prior system, air was discharged from the stems during the up and down movement of the door. Due to the insulation of the mentioned stems, the air could not be discharged from this region and the trapped air in the curtain was needed to be discharged.

Another similar objective of the invention is to create a hole shutter curtain in order to compensate the heat loss due to the ventilation holes formed for air discharge and to prevent the associated insulation loss.

In order to achieve the above-mentioned objectives, the invention includes an upper hood that allows for intervening the head portion of the upper hood, front and back hoods that are carriers of the upper structure, side hoods that transfer the load of the upper portion to the stems, stems that guide the curtains and serve as the column in the product, an operating piece that provides a connection between stems and side hoods, a bottom slat where the stems are positioned and fitted on, curtains that provides insulation when the door is closed and an upper inner organization, a base profile designed in such a way that a heat bridge will not be formed, a motor that provides the movement of the door, a sensor that provides the recognition of possible obstacles while the door is going down and stops the movement, an insulation piece that prevents inflow of the air in the curtain or in the external environment to the stems during opening or closing of the door, a bunge cable that provides movement of the curtains as desired by providing a connection between the curtains located inside and the base profile and a ventilator which is located inside the upper head portion and provides removal of the air, when needed, in order to prevent the difficulty in operation of the system caused by the humid air, ventilation holes that provide discharge of the trapped air in the curtain system during the up and down movements of the curtain and prevent inflation of the curtain, and a hole shutter curtain that closes the ventilation holes after completion of the curtain movement.

### FIGURES HELPING TO UNDERSTAND THE INVENTION

FIG. 1 presents the view of connection between curtain and base profile used in the current technique.

FIG. 2 presents the exploded view of new curtain system according to the invention.

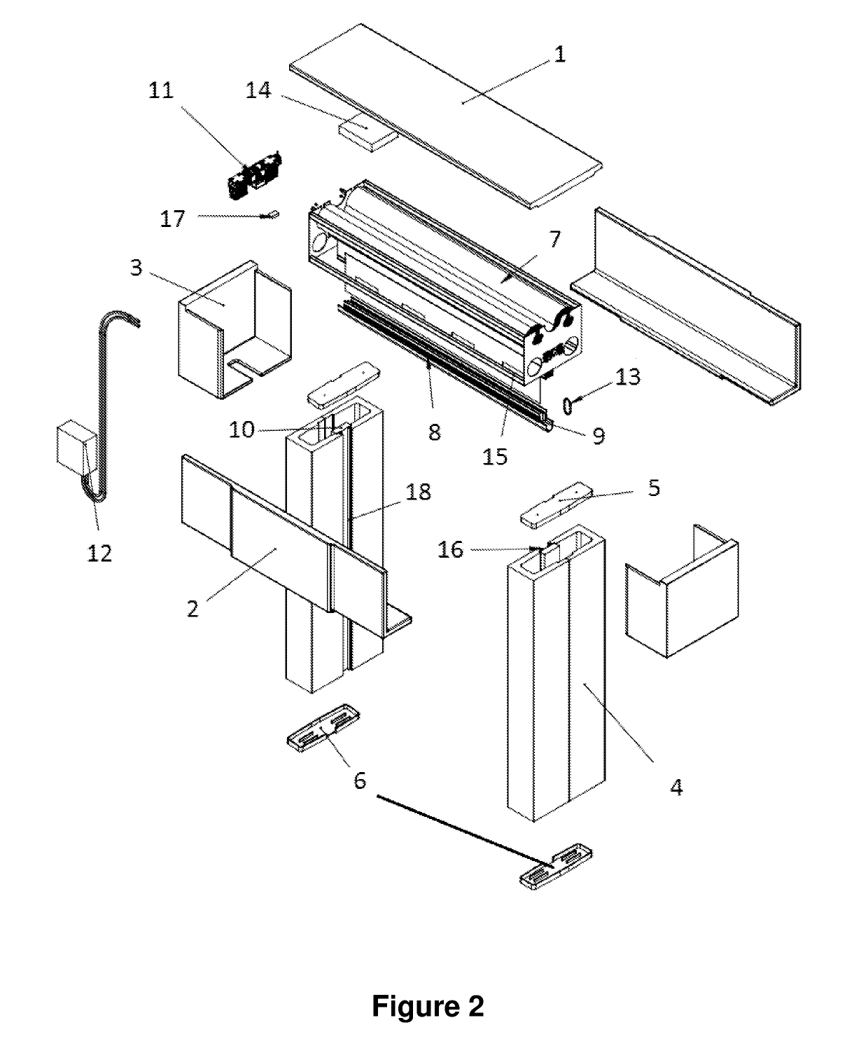

FIG. 3 presents the connection between the curtain and base profile used in the new curtain system according to the invention as well as the view of bungee cables that provide opening and closing of the system.

FIG. 4 presents the image of ventilation holes and hole shutter curtain that closes the mentioned holes.

FIG. 5 presents the posterior image of the stem and insulation piece.

FIG. 6 presents detailed view of heating cable and seal.

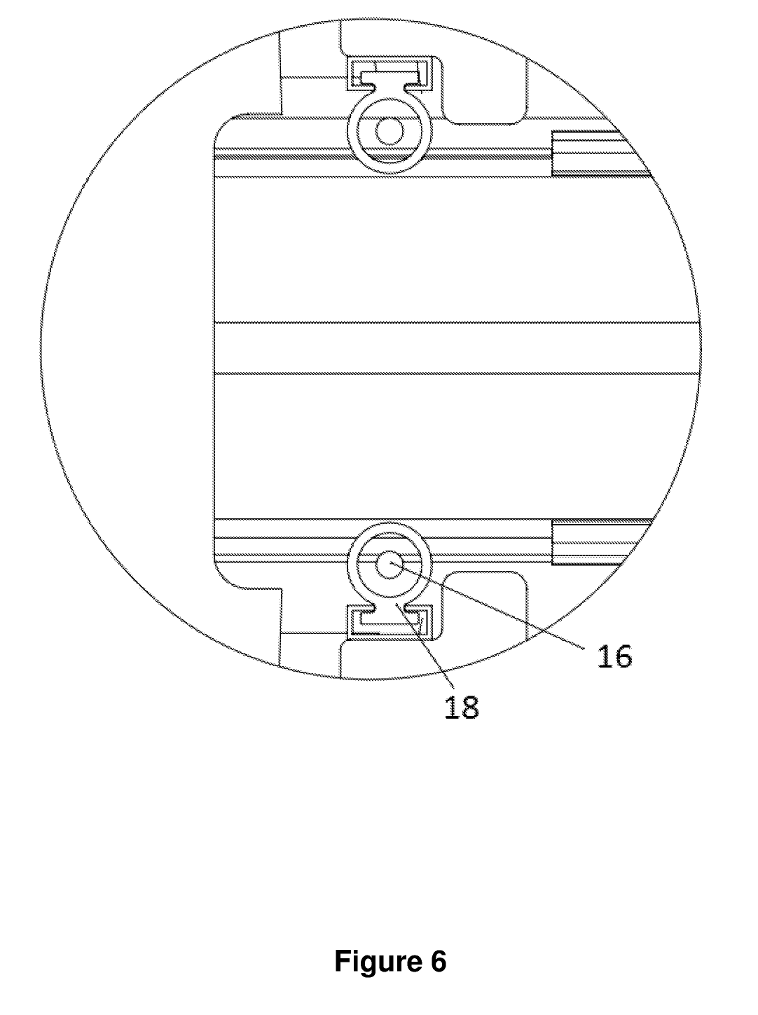

In the drawings, the identical members or the members at least having substantially identical functions are illustrated with the same numbers.

### DESCRIPTION OF THE REFERENCE PARTS

1. Upper Hood (Upper cover)

2. Front/Back Hood (Front/Back cover)

3. Side Hoods (Side cover)

4. Stems

5. Operating piece

6. Bottom slat

7. Curtain system

8. Base profile

9. Sensor

10. Insulation piece

11. Motor

12. Connecting Profile 1

13. Bunge Cable

14. Ventilator System

15. Ventilation Holes

16. Heating Cable

17. Heating System

18. Seal

19. Curtain

20. Hole shutter curtain

21. Connecting Profile 2

### DETAILED DESCRIPTION OF THE INVENTION

In this detailed description, the preferred embodiments of a new structuring for a rapid rolling type door are described only for the better understanding of the subject and will not form any limiting effect.

The frame of the door system was made up of a upper hood (1) manufactured from polyester, front/back hoods (2) providing a necessary distance for the curtains (12) to operate properly, side hoods (3) transferring the load of the said upper hood (1) region to the stems (4), an operating piece (5) preventing the sliding of upper structure by allowing the connection of stems (4) with side hoods (3) and passage of the air flow from upper regions to lower regions, and a bottom slat (6) which is fitted on the said stems (4) and mounted to the floor and prevents icing, when necessary, by connecting to a heating cable (16) which is located within itself.

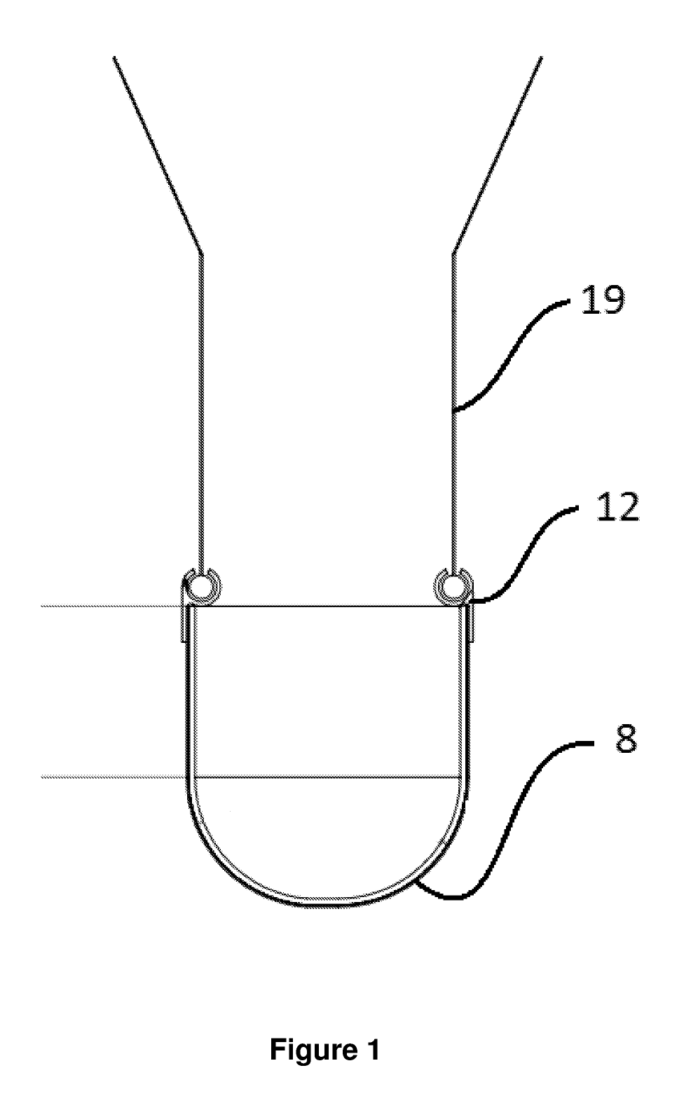

FIG. 1 shows upper hood (1), front/back hoods (2), side hoods (3), stems (4), operating piece (5) and curtain system (7) within the bottom slat (6), which are connected by mounting. Curtain system (7) is made up of multiple curtains which prevent moisture and humidity. Curtains, therein, used for the purpose of insulation are connected to the base profile (8) via bunge cables (13). These bunge cables (13) ensure that the inner curtain is exactly at the desired position. Again by the bunge cables (13), in case of closure of the door, uncontrollably upward bounce of the base profile (8) is prevented. The door moves upward and downward by a motor (11). During this movement, a sensor (9), which is positioned on the base profile (8), stops the operation of the door in case of a possible barrier during downward movement of the door by recognizing this barrier. This is of great importance in terms of security.

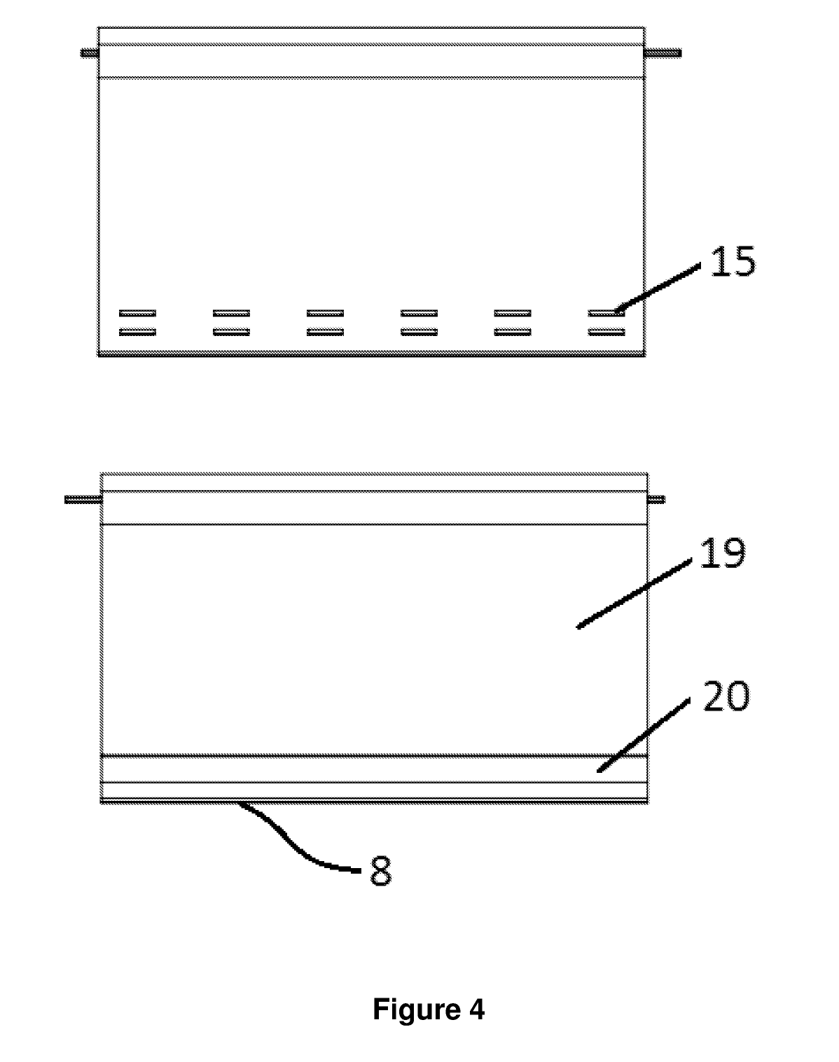

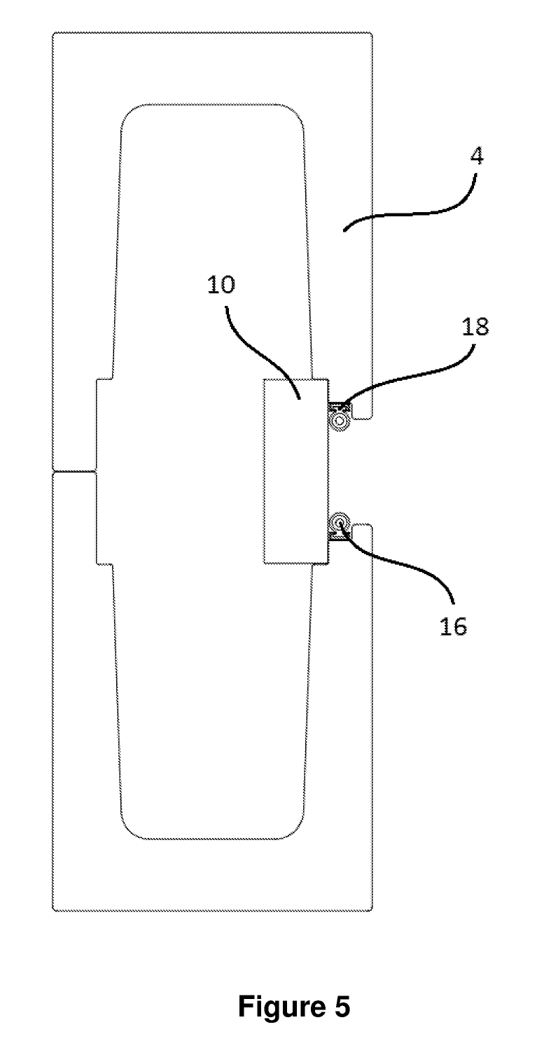

As shown in FIG. 5, entrance of air into the stems (4) is minimized by the insulation piece (10) and the seal (18) next to it. Therefore, freezing of moisture in the air within the stems (4) and its hindering the movement of the door is prevented. Furthermore, air entering into the stems (4) prevents closing of the door by creating a pressure effect during upward or downward movement of the curtain (19) in the curtain system. Air, herein, also applies a considerable amount of force to the upper hood (1) and may even lead to dislocation of the upper hood (1). In FIG. 4, ventilation holes (15) which facilitate the discharge of humid and compressed air found in the curtain system (7) are demonstrated. In the insulation system of the invention, since the stems (4) are insulated in such a way that no air enters inside, air accumulates in the curtain system (7) as it does not discharge outside from the stems (4) while the system is operating upward and downward. As the stems (4) are insulated, air cannot discharge and thereby inflates the curtain (19). For the discharge of this compressed air accumulated in the curtain system (7), ventilation holes (15) are formed. By these ventilation holes (15), curtain (19) does not inflate due to air pressure formed in the curtain system (7) depending on movement and can open and close properly. However, these said ventilation holes (15) lead to a loss in terms of insulation. In order to solve this problem, hole shutter curtain (20), which is sewed to the overhead of the bottom side of the curtain (19) so as to cover the ventilation holes (15) and is free from its bottom, is used to prevent insulation loss from ventilation holes (15) by overlying these ventilation holes (15) when movement is completed via acting as a skirt.

On the other hand, humid air within the stems (4) is discharged from the system by the ventilator system (14) found on the upper hood (1). By these ventilators (14), the force acting to the upper hood (1) is minimized.

Heat regulators (17) found in the side hoods (3) provide to keep the air in the curtain system (7) at the desired temperature values. Therefore, curtains found in the curtain system (7) are prevented from the adverse conditions that will be created by the air in the curtain system (7). Inner portion of the structure, which is made up of the upper hood (1), front/back hoods (2), and side hoods (3) and named as upper head system, is prevented from icing. Operating piece (5) found in the stems (4) also acts as a stopper that prevents the humid air in the curtain system (7) to enter in the said upper head system.

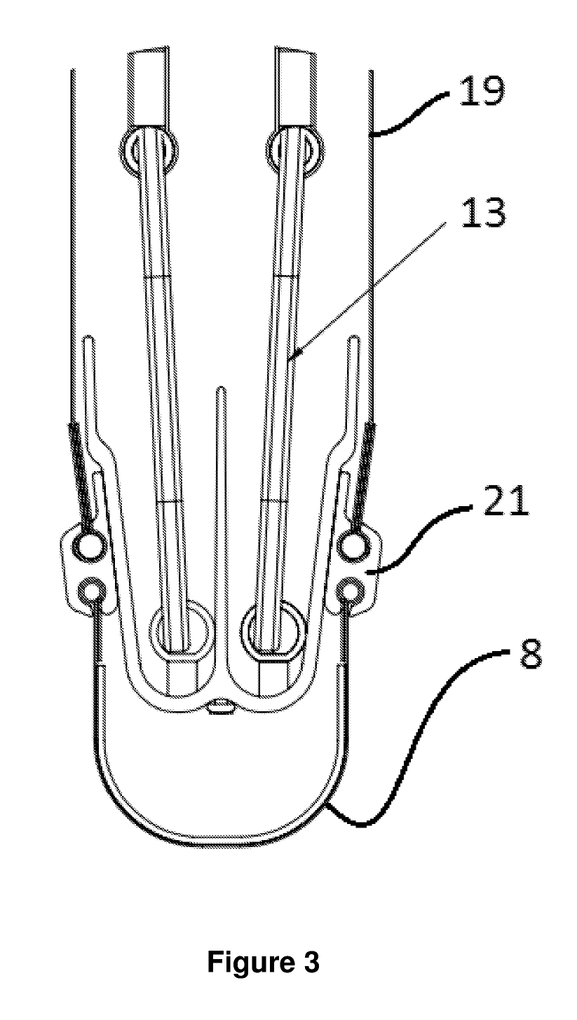

In FIG. 1, the connecting profile 1 (12), which is used in the available technique and provides a connection between the base profile (8) and curtain system (7), is illustrated. In the available technique, these connections carry the heat to the interior side and lead to a loss in terms of insulation. Moreover, in FIG. 3, connections used in the curtain system (7) of the invention are illustrated. As shown in this figure, the base profile (8) and curtain (19) is connected externally and this connection is provided by the connecting profile 2 (21). Therefore, heat transfer is prevented by increasing insulation. Outer cold air does not transfer into the inner portion of the curtain system (7) and the insulation is improved.

1. A development for the purpose of improving the insulation of the rapid rolling type doors, characterized in comprising:
an insulation piece positioned longitudinally on the stems to enable the door to operate healthy by providing the removal of accumulated air in the curtain system from the stems during up and down movement of the door and thereby preventing icing in the stems;
ventilation holes providing the discharge of the compressed air, which traps in the curtain system during up and down movement of the door because of the insulation of said stems with the insulation piece and cannot discharge from the stems due to the insulation piece, to outside from the curtain system, and
in order to prevent heat transfer due to said ventilation holes, a hole shutter curtain, one side of which is fixed on the curtain and the other side of which is free and which overlies the ventilation holes by acting as a skirt when downward movement of the door is completed and prevents heat transfer.

2. A development according to claim 1, characterized in comprising a heating cable positioned through the stems to reduce icing effect by running when necessary.

3. A development according to claim 1, characterized in comprising a seal which is an additional insulation factor to the additional insulation piece and guides to the heating cable.

4. A development according to claim 1, characterized in comprising a connecting profile which provides a connection between the base profile and curtain.
